(19) United States
(12) Patent Application Publication
(10) Pub. No.: US 2021/0084951 A1
(43) Pub. Date: Mar. 25, 2021

(54) FUNCTIONAL COMPOUND SWEETENER

(71) Applicant: Fang Bian, Tianjin (CN)

(72) Inventor: Fang Bian, Tianjin (CN)

(21) Appl. No.: 17/029,191

(22) Filed: Sep. 23, 2020

(30) Foreign Application Priority Data
Sep. 25, 2019 (CN) 201910911306.5

(51) Int. Cl. A23L 27/30

(52) U.S. Cl. CPC A23L 27/34; A23L 27/32

(57) ABSTRACT

The functional compound sweetener disclosed herein comprises a composition comprising: a high sweetness sweetener and a sweetener buffer in a weight ratio of 1:4 to 1:80,000, and 0.07 g/L to 0.15 g/L of an acid buffer for maintaining pH at 2.5 to 5.5 when the composition is dissolved in water. The functional compound sweetener imparts flavor temporal profile characteristics close to sucrose, and removes bitter taste, astringency and medicinal taste of the high sweetness sweetener, and adjusts time delay of sweet tastes to obtain taste closer to sucrose, such that food supplemented with the functional compound sweetener reduces caloric intake and risk of diabetes while satisfying a sweetness taste.

### CROSS-REFERENCE TO RELATED APPLICATIONS

This application claims priority to Chinese Patent Application No. 201910911306.5, filed with the China National Intellectual Property Administration (CNIPA) on Sep. 25, 2019, the content of which is incorporated herein by reference in its entirety.

Some references, if any, which may include patents, patent applications and various publications, may be cited and discussed in the description of this application. The citation and/or discussion of such references, if any, is provided merely to clarify the description of the present application and is not an admission that any such reference is “prior art” to the application described herein. All references listed, cited and/or discussed in this specification are incorporated herein by reference in their entireties and to the same extent as if each reference was individually incorporated by reference.

### FIELD OF THE PRESENT APPLICATION

The disclosure herein relates to the technical field of food additives, and particularly to a functional compound sweetener.

### BACKGROUND

Sugar is an important condiment for people in making food. Sugar is divided into high-caloric sweeteners and low-caloric sweeteners depending on contained calories. Natural sweeteners, such as sucrose and honey, contain high calories, and easily cause obesity, even diabetes, if long-term excessively consuming. The low-caloric sweeteners refer to substances having sweet tastes, producing low calories and having low nutritive value. Such sweeteners are often to control blood glucose elevation, avoid obesity, control weight and prevent cardiovascular disease from occurring, and also serve as substitution of sugar for diabetics. The natural low-caloric sweeteners obtained from plants are popular since their safety is far higher than that of artificial synthetic sugar, and include stevia extracted from Stevia rebaudiana leaves and having a sweetness roughly 300 times than sucrose, triterpenoid separated from Luo Han Guo and having a sweetness roughly 150 times than sucrose, glycyrrhizin extracted from licorice and having a sweetness roughly 80-300 times than sucrose, and mogroside extracted from Luo Han Guo and having a sweetness roughly 240 times than sucrose. In addition, the artificial synthetic functional sweeteners are widely used due to low calories, high sweetness and pure sweet tastes, and include sucralose having a sweetness roughly 600 times than sucrose, acesulfame having a sweetness roughly 250 times than sucrose, alitame having a sweetness roughly 2000 times than sucrose, and aspartame having a sweetness roughly 200 times than sucrose.

The main receptor of tastes in a person's mouth consists of gustatory buds distributed within epithelium of lingual papilla, soft palate, epiglottis and pharyngeal mucosa. The gustatory buds have holes in communication with the mouth on top ends and are formed of gustatory cells and supporting cells. People have about nine thousand gustatory bud cells, and every forty to sixty gustatory cells form a gustatory bud. The gustatory buds feeling sweet tastes are mainly distributed on an apex of tongue, and the gustatory buds feeling sour tastes are mostly in the latter part of both sides of the tongue. No matter whether the high sweetness sweetener is extracted from plant, or synthesized, it is obviously different from the natural sugar (hereinafter referred to as sugar) in taste and flavor temporal profile. A large number of lactic acid bacteria are present on surfaces of the gustatory buds in mouth of human and other mammals, and when eating, trace sugar and lactic acid bacteria ferment to produce organic acids, such as lactic acid, acetic acid (ethyl alcohol), and the like. When people eat, concentration change curve of the main composition of sugar metabolism is as shown in FIG. 1. Sweet tastes of sugar gradually decrease because of swallowing, since the organic acids are weak acids, a pH value of sour tastes is less affected by concentration, and when sweet tastes decrease to a certain level, sour tastes begin to appear. The time-pH curve during sugar metabolism is shown in FIG. 2. Chemical properties of sweetener are more stable than that of sugar, and the sweetener won't react with yeasts and bacteria in the mouth to generate organic acids. Concentration change of the main composition is shown in FIG. 3. The pH value is substantially maintained at 7, and the specific time-pH curve is shown in FIG. 4. Tastes are always sweet, and sweet tastes appear slower and maintain longer, such that the high sweetness sweetener changes balance of flavor temporal profile of food, and exhibits off tastes such as bitter taste, metallic taste, astringency, licorice taste, cool sensation, and sweetness which diminishes on iterative tasting. Therefore, it is necessary to change the taste of the high sweetness sweetener extracted from plant or synthesized to promote the advantageous health benefits in food.

### SUMMARY OF THE APPLICATION

With respect to the deficiencies in the prior art, the functional compound sweetener disclosed herein solves defects of flavor and taste of the high sweetness sweeteners in the prior art.

The functional compound sweetener disclosed herein comprises a sweetener composition comprising a high sweetness sweetener and a sweetener buffer in a weight ratio of 1:4 to 1:80,000, and an acid buffer for maintaining pH 2.5 to 5.5, preferably pH 3.0 to 5.0, and most preferably pH 4.0 to 4.5, when the composition is dissolved in water.

In one aspect, the high sweetness sweetener of the sweetener composition comprises one or more compounds selected from the group consisting of a steviol glycoside, glycyrrhirin, mogroside, siamenoside, raspberry extract, thaumatin, curcurbin, monellin, mabinlin, brazzein, and hernandulcin.

In one embodiment, the steviol glycoside is selected from the group consisting of stevioside, rebaudioside A, rebaudioside B, rebaudioside C, rebaudioside D, rebaudioside E, rebaudioside F, dulcoside A, and rubusoside.

In another embodiment the glycyrrhizin is selected from the group consisting of glycyrrhizinic acid, tripotassium glycyrrhizinate, trisodium glycyrrhizinate, monoammonium glycyrrhizinate, ammonium glycyrrhetate, mono potassium glycyrrhinate, and tripotassium glycyrrhinate.

In another embodiment, the mogroside is selected from the group consisting of Lou Han Guo sweetener, mogrol, mogroside II A1, mogroside II B, 7-oxomogroside II E, 11-oxomogroside A1, mogroside III A2, 11-deoxymogroside III, 11-oxomogroside IV A, mogroside V, 7-oxomogroside V, 11-oxo-mogroside V, mogroside VI, osladine, polypodoside A, and polypodoside B.

In another aspect, the high sweetness sweetener is selected from the group consisting of sodium cyclamate, calcium cyclamate, betahistine, acesulfame-K, aspartame, L-alpha-aspartyl-N-(2,2,4,4-tetramethyl-3-trimethylene sulfide)-D-alanine amide, aspartyl phenylalanine methyl acetylsulfonic acid, sucralose, acesulfame potassium, aspartyl phenylalanine methyl ester, saccharin, cyclamate, neohysperidine dihydrochalcone, and N—[N(3,3-dimethylbutyl)]-L-alpha-aspartic-L-phenylalanine 1-methyl ester.

Preferably, the high sweetness sweetener is sucralose, steviol glycoside, aspartame, neotame, or mogroside.

In another aspect, the sweetener buffer of the sweetener composition is selected from the group consisting of xylitol, sorbitol, D-mannitol, maltitol, isomalt, erythritol, galactitol, lactitol, raffinose, lactose, maltose, alpha-D-glucose, alpha-D-mannose, alpha-D-xylose, alpha-D-galactose, beta-D-fructofuranose, beta-D-maltose, beta-D-lactose, gelatin, sodium caseinate, arabic gum, tamarind gum, sesbania gum, agar, sodium alginate, potassium alginate, carrageenan, pectin, xanthan gum, beta-cyclodextrin, sodium carboxymethylcellulose, sodium starch phosphate, sodium carboxymethyl starch, hydroxypropyl starch, and propylene glycol alginate In another aspect the sweetener buffer comprises one or more of raffinose, lactose, maltose, alpha-D-glucose, alpha-D-mannose, alpha-D-xylose, alpha-D-galactose, beta-D-fructofuranose, beta-D-maltose, and beta-D-lactose.

Preferably, the sweetener buffer is erythritol and/or maltitol.

In another aspect, the acid buffer of the sweetener composition is selected from the group consisting of tannic acid, lactic acid, tartaric acid, citric acid, fumaric acid, gluconic acid, hydroxycitric acid, malic acid, maleic acid, succinic acid, salicylic acid, creatine, glucosamine hydrochloride, glucono delta lactone, acetic acid, ascorbic acid, adipic acid, oxalic acid, n-butyric acid, methanoic acid, polyglutamic acid, phosphoric acid, phosphorous acid, polyphosphoric acid, carbonic acid, sodium dihydrogen phosphate, and inositol hexaphosphate.

In another aspect of the functional compound sweetener, the acid buffer is about 0.1 wt % of the composition.

In another embodiment of the sweetener composition, the high sweetness sweetener is selected from the group consisting of sucralose, steviol glycoside, aspartame, neotame, and mogroside.

In another embodiment of the functional compound sweetener, the sweetener buffer is erythritol and/or maltitol.

In another aspect of the functional compound sweetener, the sweetener composition essentially consists of sucralose; erythritol or maltitol; and citric acid. In a preferred aspect, the ratio of sucralose:erythritol or sucralose:maltitol is 5:1000.

In another aspect of the functional compound sweetener, the sweetener composition essentially consists of stevioside; erythritol or maltitol; and an acid buffer selected from citric acid, tartaric acid, malic acid, lactic acid, vitamin C, and fumaric acid. In as preferred aspect, the ratio of stevioside:erythritol or stevioside:maltitol is 4:1000 to 5:1000.

In another aspect of the functional compound sweetener, the sweetener composition essentially consists of aspartame; erythritol or maltitol; and citric acid or tartaric acid. In a preferred aspect, the ratio of aspartame:erythritol or aspartame:maltitol is 18:1000 to 25:1000.

In another aspect of the functional compound sweetener, the sweetener composition essentially consists of mogrosides:erythritol or maltitol; and citric acid or tartaric acid. In a preferred aspect, the ratio of mogrosides:erythritol or mogrosides:maltitol is 12:1000.

In another aspect of the functional compound sweetener, the concentration of the sweetener composition is about 0.1 g/ml.

In another aspect of the functional compound sweetener, the relative concentration of the acid buffer in the sweetener composition is about 0.1 wt %.

Preferably, the functional compound sweetener comprises 1.1 g/L of acesulfame, 0.06 g/L of citric acid and 100 g/L of erythritol.

Preferably, the functional compound sweetener comprises 0.3 g/L of aspartame, 0.2 g/L of sucralose, 0.13 g/L of vitamin C, 50 g/L of erythritol and 75 g/L of maltitol.

Preferably, the functional compound sweetener comprises 3 g/L of sodium cyclamate, 0.02 g/L of alitame, 0.04 g/L of phosphoric acid, 0.03 g/L of glutamic acid, 60 g/L of erythritol, and 60 g/L of maltitol.

Preferably, the functional compound sweetener comprises 2.4 g/L of rebaudioside C, 0.8 g/L of dulcoside A, 00.9 g/L of acetic acid, 0.06 g/L of adipic acid, 30 g/L of xylitol, 24 g/L of sorbitol, and 24 g/L of isomalt.

Preferably, the functional compound sweetener comprises 0.18 g/L of rebaudioside A, 0.05 g/L of thaumatin, 0.02 g/L of phosphoric acid, 0.05 g/L of glutamic acid, 80 g/L of erythritol, and 30 g/L of maltitol.

Preferably, the functional compound sweetener comprises sucralose, erythritol and maltitol in a weight ratio of 3:800:300, and vitamin C for maintaining a pH 4.0 to 5.0 when the composition is dissolved in water.

Preferably, the functional compound sweetener comprises steviol glycoside, erythritol and maltitol in a weight ratio of 4:800:300, and citric acid for maintaining a pH 3.0 to 4.0 when the composition is dissolved in water.

As compared to the prior art, the advantageous effects of the embodiments of the functional compound sweetener are to impart flavor temporal profile characteristics of sucrose, particularly a flavor temporal profile in which time delay of sweetness taste resembles sucrose, and in which bitter taste, astringency, medicinal taste associated with the high sweetness sweetener are diminished or removed. Food supplemented with the functional compound sweetener has the benefit of reducing caloric intake and risk of diabetes while satisfying people with the sweetness taste of sucrose.

### BRIEF DESCRIPTION OF THE DRAWINGS

The above features and advantages will become clearer and easier to understand by describing the exemplary embodiments hereinafter with reference to the accompanying drawings.

FIG. 1 is a time-concentration curve of the main composition during oral metabolism of sugar.

FIG. 2 is a time-pH curve during oral metabolism of sugar.

FIG. 3 is a time-concentration curve of the main composition during oral metabolism of sweetener.

FIG. 4 is a time-pH curve during oral metabolism of sweetener.

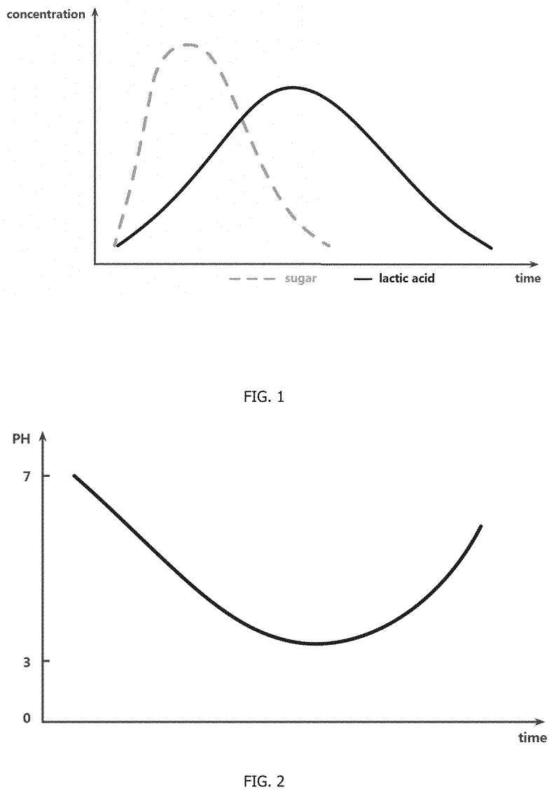

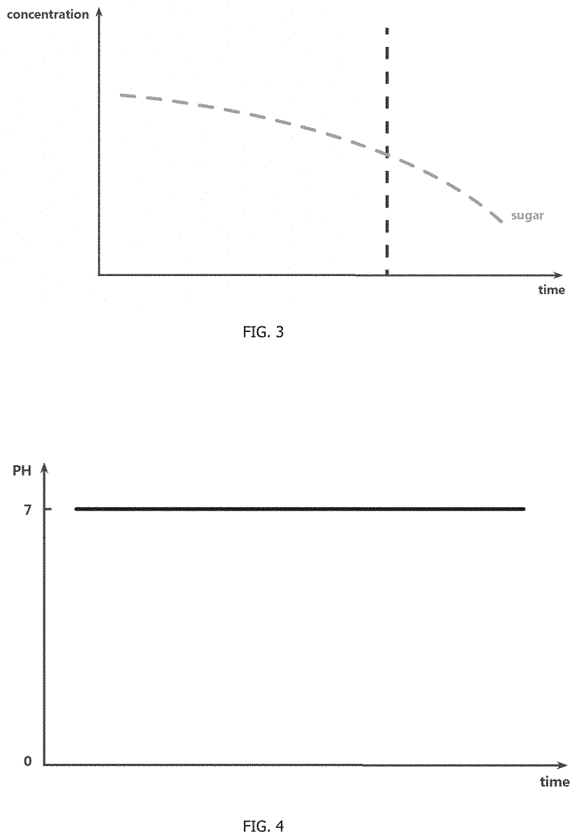

Hereinafter the functional compound sweetener disclosed herein is further explicitly explained with reference to the accompanying drawings to facilitate understanding of those skilled in the art.

### DESCRIPTION OF THE PREFERRED EMBODIMENT

The functional compound sweetener disclosed herein with improved flavor temporal profile characteristics of sweetener, which improves the flavor temporal profile characteristics by imparting flavor temporal profile characteristics close to sucrose. The functional compound sweetener comprises a high sweetness sweetener and a sweetener buffer in a weight ratio of 1:4 to 1:80,000, and an acid buffer capable of maintaining a pH 2.5 to 5.5 after dissolving in water. The terminology “flavor” used herein includes sweet taste, sour taste, bitter taste, astringency and metallic taste. The terminology “improve” used herein refers to “change”, “modify”, “adjust”, “weaken”, “decrease”, “reduce”, “restrain”, “enhance”, “supplement” or “strengthen”.

I. High Sweetness Sweetener

The high sweetness sweetener refers to substances having a sweetness potency greater than sucrose, fructose, or glucose, yet have less calories. The high sweetness sweetener of the functional compound sweetener disclosed herein comprises natural high sweetness sweetener and synthetic high sweetness sweetener, and non-limiting examples comprise: sodium cyclamate, calcium cyclamate, L-alpha-aspartyl-N-(2,2,4,4-tetramethyl-3-trimethylene sulfide)-D-alanine amide (alitame), aspartyl phenylalanine methyl acetylsulfonic acid, sucralose, acesulfame potassium (acesulfame), aspartyl phenylalanine methyl ester (aspartame), saccharin, neohysperidine dihydrochalcone (NHDC), N—[N-(3,3-dimethylbutyl)]-L-alpha-aspartic-L-phenylalanine 1-methyl ester (neotame), rebaudioside A, rebaudioside B, rebaudioside C, rebaudioside D, rebaudioside E, dulcoside A, steviol glycoside, Lou Han Guo sweetener (mogroside), mogroside IV, mogroside V, siamenoside, tripotassium glycyrrhizinate, trisodium glvcyrrhizinate, monoammonium glycyrrhizinate, ammonium glycyrrhetate, mono potassium glycyrrhinate, tripotassium glycyrrhinate, thaumatin, curculin, monellin, mabinlin, brazzein, hemandulcin, rubusoside, osladin, polypodoside, betahistine, cyclamate, glycyrrhizin, acesulfame-K, aspartame, monk fruit sweetener (grosvenorii) (Hunan Huacheng Biotech. Inc., and raspberry extract (Ningxian Hengrekang Biotech, Inc.).

In one embodiment of the functional compound sweetener disclosed herein, the high sweetness sweetener has a purity range from about 50% to about 100%, from about 70% to about 100%, from about 80% to about 100%, from about 90% to about 100%, from about 95% to about 100%, from about 98% to about 100%, and from about 99% to about 100%.

In the embodiments of the functional compound sweetener, the high sweetness sweetener can be used separately, or in combination with other high sweetness sweeteners. For example, the high sweetness sweetener may contain a singular natural sweetener, or a singular synthetic sweetener, and a combination of one or more natural sweeteners and one or more synthetic sweeteners.

Take the combination of steviol glycosides for example, non-limiting examples of high sweetness sweeteners of suitable steviol glycosides that can be combined together comprise rebaudioside A, rebaudioside B, rebaudioside C, rebaudioside D, rebaudioside E, dulcoside A, and stevioside. The chemical structure of steviol glycosides have the formula R1-steviol-R2, wherein

Stevioside: R1 is β-glc- and R2 is β-glc-β-glc

Rebaudioside: R1 is β-glc- and R2 is (β-glc)2-β-glc

Rebaudioside B: R1 is H- and R2 is (β-glc)2-β-glc

Rebaudioside: R1 is β-glc- and R2 is (β-glc)2-α-glc

Rebaudioside D: R1 is β-glc-β-glc- and R2 is (β-glc)2-β-glc

Rebaudioside E: R1 is β-glc-β-glc- and R2 is β-glc-β-glc

Rebaudioside F: R1 is β-glc- and R2 is (β-glc)2-α-glc

Steviolbioside: R1 is H- and R2 is (β-glc)2-β-glc

Dulcoside A: R1 is β-glc- and R2 is (β-glc)2-α-rha

Rubusoside: R1 is β-glc- and R2 is β-glcaR1,

wherein steviol has the following structure

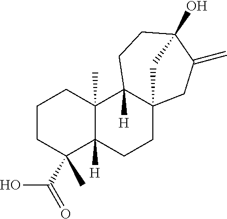

and
glc is D-glucopyranosyl; rha is L-rhamnopyranosyl; and xyl is D-xylopyranosyl. According to the functional compound sweetener, rebaudioside A in the combination of high-potency sweeteners is in an amount from 50% to 99% (weight), preferably 70% to 90% (weight), and more preferably 75% to 85% (weight). Rebaudioside B is in an amount from 1% to 8% (weight), preferably 2% to 5% (weight), and more preferably 2% to 3% (weight). Rebaudioside C is in an amount from 1% to 10% (weight), preferably 3% to 8% (weight), and more preferably 4% to 6% (weight). Rebaudioside E is in an amount from 0.1% to 4% (weight), preferably 0.1% to 2% (weight), and more preferably 0.5% to 1% (weight). Dulcoside A is in an amount from 0.1% to 4% (weight), preferably 0.1% to 2% (weight), and more preferably 0.5% to 1% (weight). Stevioside is in an amount from 0.5% to 10% (weight), preferably 1% to 6% (weight), and more preferably 1% to 4% (weight).

In one preferable embodiment of the functional compound sweetener, the high sweetness sweetener comprises a mixture of rebaudioside A, stevioside, rebaudioside B, rebaudioside C and rebaudioside E, wherein rebaudioside A is in an amount of 75% to 85% (weight) based on the total weight of the high sweetness sweetener, stevioside is in an amount of 1% to 6% (weight), rebaudioside B is in an amount of 2% to 5% (weight), rebaudioside C is in an amount of 3% to 8% (weight), and rebaudioside E is in an amount of 0.1% to 2% (weight).

There are some sweeteners stable at higher than 200 centigrade, selected from the group consisting of steviol glycosides, sodium cyclamate, maltitol, aspartame, isomaltulose, neotame, acesulfame potassium, and sucralose. Using these materials with acid buffer that is also stable at high temperature build the sweetener is suitable for bakery and/or to mix in fried foods.

II. Sweetener Buffer

The sweetener buffer comprises substances having a sweetness potency lower than or equal to sucrose, fructose, or glucose, yet have less calories, such as, sugar alcohol, polyol, or polyglycol in a reduction form of saccharides, wherein carbonyl (aldehyde or ketone, reductive saccharide) has been reduced to primary or secondary hydroxyl.

Non-limiting examples of the sweetener buffer in the functional compound sweetener comprise xylitol, sorbitol, D-mannitol, maltitol, isomalt, erythritol, galactitol, lactitol (4-beta-D galactopyranose-D-sorbitol); raffinose, lactose, maltose, isomaltulose hydrate, alpha-D-glucose, alpha-D-mannose, alpha-D-xylose, alpha-D-galactose, beta-D-fructofuranose, beta-D-maltose, beta-D-lactose; gelatin, sodium caseinate, arabic gum, tamarind gum, sesbania gum, agar, sodium alginate, potassium alginate, carrageenan, pectin, xanthan gum, beta-cyclodextrin, sodium carboxymethylcellulose, sodium starch phosphate, sodium carboxymethyl starch, hydroxypropyl starch, or propylene glycol alginate.

In one embodiment of the functional compound sweetener disclosed herein comprises at least one high sweetness sweetener and at least one sweetener buffer, preferably two or more sweetener buffers, and more preferably three or more sweetener buffers. Flavor of the functional compound sweetener is not affected, and sweet tastes of the functional compound sweetener are balanced by controlling the amount of the singular sweetener buffer and the total amount of various sweetener buffers.

In one embodiment of the functional compound sweetener comprises at least one high sweetness sweetener and at least one sweetener buffer. When the amount of the comprised at lea composition comprising st one high sweetness sweetener is sufficient to provide sweetness with the maximum sweetness corresponding to 10% (weight) of sucrose aqueous solution when dissolving in water, the amount of the at least one sweetener buffer effectively enables aqueous solution of the functional compound sweetener to have an osmolarity of at least 50 mOsmoles/L, preferably 50 to 500 mOsmoles/L, more preferably 100 to 500 mOsmoles/L, more preferably 300 to 500 mOsmoles/L, and still more preferably 350 to 500 mOsmoles/L. When the functional compound sweetener comprises two or more sweetener buffers, the provided osmolarity is an osmolarity provided after combining the two or more sweetener buffers.

In one embodiment of the functional compound sweetener disclosed herein, a molecular weight of the sweetener buffer is less than or equal to 500, preferably from 50 to 500, and more preferably from 76 to 500. In one preferably embodiment, the sweetener buffer less than or equal to 500 includes, but is not limited to, erythritol, glycerol, and propylene glycol. According to one embodiment of the functional compound sweetener, the sweetener buffer is present in the functional compound sweetener in an amount from 50,000 ppm to about 400.000 ppm (ppm means parts per million by weight or volume. For example, 500 ppm means 500 mg in a liter). According to another preferable embodiment of the functional compound sweetener, the sweetener buffer is present in the functional compound sweetener in an amount from 100,000 ppm to about 350,000 ppm, preferably 150,000 to 300,000 ppm, and more preferably 200,000 to 250.000 ppm. In another specific example, the sweetener buffer for imparting the osmolarity ranging from about 50 mOsmoles/L to about 500 mOsmoles/L to a sweetenable composition includes, but is not limited to, the sweetener buffer with a molecular weight ranging from 50 to 500. According to one embodiment, the functional compound sweetener comprises a composition comprising at least one high sweetness sweetener and at least one sweetener buffer. The at least one high sweetness sweetener and the at least one sweetener buffer are present in a weight ratio from 1:4 to 1:80,000, preferably from 1:20 to 1:2500, more preferably from 1:50 to 1:300, and still more preferably from 1:75 to 1:150.

III. Acid Buffer

An organic acid buffer includes any compound which comprises a —COOH moiety. Sweet taste improving organic acid additives of the functional compound sweetener disclosed herein include, but are not limited to, C2-C30 carboxylic acids, substituted hydroxyl C1-C30 carboxylic acids, substituted cinnamic acids, hydroxyacids, substituted hydroxybenzoic acids, substituted cyclohexyl carboxylic acids, tannic acid, lactic acid, tartaric acid, citric acid, gluconic acid, hydroxycitric acid, malic acid, fumaric acid, maleic acid, succinic acid, salicylic acid, creatine, acetic acid, ascorbic acid, adipic acid, oxalic acid, n-butyric acid, methanoic acid, polyglutamic acid, glucosamine hydrochloride, glucono delta lactone, and their alkali or alkaline earth metal salt derivatives thereof.

Sweet taste improving inorganic acid buffers of the functional compound sweetener include, but are not limited to, phosphoric acid, phosphorous acid, polyphosphoric acid, carbonic acid, sodium dihydrogen phosphate, and their corresponding alkali or alkaline earth metal salts thereof (e.g., inositol hexaphosphate Mg/Ca).

In other embodiments, the functional compound sweetener comprising a composition comprising weight percentages (in a liquid state or a solid state) of the organic acid and/or inorganic acid additives in the functional compound sweetener maintain the pH value of the composition dissolved in 1 L purified water at pH 2.0 to 5.5, preferably pH 3.0 to 5.0, and more preferably 4 to 4.5. In addition, the organic acid and the inorganic acid can be used separately or in combination in the functional compound sweetener to obtain a pH value from 2.0 to 5.5, preferably from 3.0 to 5.0.

the functional compound to impart flavor temporal profile characteristics of sucrose, particularly a flavor temporal profile in which time delay of sweetness taste resembles sucrose, and in which bitter taste, astringency, medicinal taste associated with the high sweetness sweetener are diminished or removed.

Hereinafter the functional compound sweetener is further explained by the examples, which are not to be construed in any way as imposing limitations upon the scope of what is disclosed herein. Unless otherwise specified, %'s are by weight.

### EXAMPLE SET A

### Example A1

Firstly, 1,000 g purified water was added into a heating container and heated to 40-50° C., 1.1 g acesulfame was added and stirred evenly to be dissolved, then 0.06 g citric acid and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example A2

Firstly, 1,000 g purified water was added into a heating container and heated to 40-50° C., 0.3 g aspartame and 0.2 g sucralose were added and stirred evenly to be dissolved, then 0.13 g vitamin C and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example A3

Firstly, 1,000 g purified water was added into a heating container and heated to 40-50° C., 0.3 g aspartame and 0.2 g sucralose were added and stirred evenly to be dissolved, then 0.13 g vitamin C, 50 g erythritol and 75 g maltitol were added and heated to 95° C. after stirring and dissolving, and temperature was preserved for 7 minutes for sterilization, so as to prepare the functional compound sweetener having a theoretical sweetness to be 4 times than sucrose.

### Example A4

Firstly, 1,000 g purified water was added into a heating container and heated to 40-50° C., 3 g sodium cyclamate and 0.02 g alitame were added and stirred evenly to be dissolved, then 0.04 g phosphoric acid, 0.03 g glutamic acid, 60 g erythritol and 60 g maltitol were added and heated to 95° C. after stirring and dissolving, and temperature was preserved for 7 minutes for sterilization, so as to prepare the functional compound sweetener having a theoretical sweetness to be 4 times than sucrose.

### Example A5

Firstly, 1,000 g purified water was added into a heating container and heated to 40-50° C. 0.2 g sucralose, 0.2 g aspartame and 0.2 g acesulfame were added and stirred evenly to be dissolved, then 0.09 g acetic acid, 0.06 g adipic acid, 30 g xylitol, 24 g sorbitol and 24 g isomalt were added and heated to 95° C. after stirring and dissolving, and temperature was preserved for 7 minutes for sterilization, so as to prepare the functional compound sweetener having a theoretical sweetness to be 4 times than sucrose.

### Example A6

Firstly, 3.000 g purified water was added into a heating container and heated to 40-50° C., 0.9 g sucralose was added and stirred evenly to be dissolved, then 0.3 g fumaric acid, 50 g xylitol, 100 g pectin and 100 g beta-cyclodextrin were added and heated to 95° C. after stirring and dissolving, and temperature was preserved for 7 minutes for sterilization, so as to prepare the functional compound sweetener having a theoretical sweetness to be 4 times than sucrose.

### EXAMPLE SET B

### Example B1

Firstly, 1.000 g purified water was added into a heating container and heated to 40-50° C., 0.35 g rebaudioside A was added and stirred evenly to be dissolved, then 0.06 g citric acid and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example B2

Firstly, 1,000 g purified water was added into a heating container and heated to 40-50° C., 0.18 g rebaudioside A and 0.2 g steviol glycoside were added and stirred evenly to be dissolved, then 0.13 g vitamin C, 200 g lactose, and 75 g maltose were added and heated to 95° C. after stirring and dissolving, and temperature was preserved for 7 minutes for sterilization, so as to prepare the functional compound sweetener having a theoretical sweetness to be 4 times than sucrose.

### Example B3

Firstly, 1,000 g purified water was added into a heating container and heated to 40-50° C. 2.4 g rebaudioside C and 0.8 g dulcoside A were added and stirred evenly to be dissolved, then 0.09 g acetic acid, 0.06 g adipic acid, 30 g xylitol, 24 g sorbitol and 24 g isomal were added and heated to 95° C. after stirring and dissolving, and temperature was preserved for 7 minutes for sterilization, so as to prepare the functional compound sweetener having a theoretical sweetness to be 4 times than sucrose.

### Example B4

Firstly, 1,000 g purified water was added into a heating container and heated to 40-50° C., 0.18 g rebaudioside A and 0.05 g thaumatin were added and stirred evenly to be dissolved, then 0.02 g phosphoric acid, 0.05 g glutamic acid, 80 g erythritol and 30 g maltitol were added and heated to 95° C. after stirring and dissolving, and temperature was preserved for 7 minutes for sterilization, so as to prepare the functional compound sweetener having a theoretical sweetness to be 4 times than sucrose.

### Example B5

Firstly, 1.000 g purified water was added into a heating container and heated to 40-50° C., 0.18 g rebaudioside A and 0.15 g sucralose were added and stirred evenly to be dissolved, then 0.09 g acetic acid, 0.06 g adipic acid, 30 g xylitol and 48 g isomalt were added and heated to 95° C. after stirring and dissolving, and temperature was preserved for 7 minutes for sterilization, so as to prepare the functional compound sweetener having a theoretical sweetness to be 4 times than sucrose.

### Example B6

Firstly, 1,000 g purified water was added into a heating container and heated to 40-50° C., 0.21 g rebaudioside A, 0.06 g sucralose and 0.01 g monellin were added and stirred evenly to be dissolved, then 0.02 g fumaric acid, 0.02 g tartaric acid, 0.02 g acetic acid, 30 g xylitol and 48 g isomalt were added and heated to 95° C. after stirring and dissolving, and temperature was preserved for 7 minutes for sterilization, so as to prepare the functional compound sweetener having a theoretical sweetness to be 4 times than sucrose.

### Example B7

Firstly, 3,000 g purified water was added into a heating container and heated to 40-50° C., 1.2 g steviol glycoside was added and stirred evenly to be dissolved, then 0.15 g fumaric acid, 0.15 g tartaric acid, 120 g sorbitol, 150 g maltitol and 100 g beta-cyclodextrin were added and heated to 95° C. after stirring and dissolving, and temperature was preserved for 7 minutes for sterilization, so as to prepare the functional compound sweetener having a theoretical sweetness to be 4 times than sucrose.

### EXAMPLE SET C

### Example C1

Firstly, 1,000 g purified water was added into a heating container and heated to 40-50° C., 0.3 g mogroside IV and 0.2 g mogroside V were added and stirred evenly to be dissolved, then 0.06 g citric acid and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example C2

Firstly, 1,000 g purified water was added into a heating container and heated to 40-50° C., 0.3 g Lou Han Guo sweetener and 0.06 g siamenoside were added and stirred evenly to be dissolved, then 0.13 g vitamin C and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example C3

Firstly, 1,000 g purified water was added into a heating container and heated to 40-50° C., 0.15 g sucralose and 0.25 g Lou Han Guo sweetener were added and stirred evenly to be dissolved, then 0.09 g acetic acid, 0.06 g adipic acid, 80 g erythritol and 30 g maltitol were added and heated to 95° C. after stirring and dissolving, and temperature was preserved for 7 minutes for sterilization, so as to prepare the functional compound sweetener having a theoretical sweetness to be 4 times than sucrose.

### Example C4

Firstly, 1,000 g purified water was added into a heating container and heated to 40-50° C., 0.21 g rebaudioside A and 0.02 g monellin were added and stirred evenly to be dissolved, then 0.02 g phosphoric acid, 0.05 g glutamic acid, 80 g erythritol and 30 g maltitol were added and heated to 95° C. after stirring and dissolving, and temperature was preserved for 7 minutes for sterilization, so as to prepare the functional compound sweetener having a theoretical sweetness to be 4 times than sucrose.

### Example C5

Firstly, 1,000 g purified water was added into a heating container and heated to 40-50° C., 0.06 g sucralose, 0.02 g thaumatin and 0.3 g mogroside IV were added and stirred evenly to be dissolved, then 0.02 g fumaric acid, 0.02 g tartaric acid, 0.02 g acetic acid, 30 g xylitol and 48 g isomalt were added and heated to 95° C. after stirring and dissolving, and temperature was preserved for 7 minutes for sterilization, so as to prepare the functional compound sweetener having a theoretical sweetness to be 4 times than sucrose.

### Example C6

Firstly, 1,000 g purified water was added into a heating container and heated to 40-50° C., 1.5 g Lou Han Guo sweetener was added and stirred evenly to be dissolved, then 0.21 g glutamic acid, 200 g lactitol (4-beta-D galactopyranose-D-sorbitol), 120 g isomaltulose and 100 g pectin were added and heated to 95° C. after stirring and dissolving, and temperature was preserved for 7 minutes for sterilization, so as to prepare the functional compound sweetener having a theoretical sweetness to be 4 times than sucrose.

### EXAMPLE SET D

### Example D1

Firstly, 1,000 g purified water was added into a heating container and heated to 40-50° C., 0.8 g glycyrrhizicacid (glycyrrhizin) were added and stirred evenly to be dissolved, then 0.06 g citric acid and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example D2

Firstly, 1.000 g purified water was added into a heating container and heated to 40-50° C., 0.5 g glycyrrhizicacid (glycyrrhizin) and 0.3 g ammonium glycyrrhetate were added and stirred evenly to be dissolved, then 0.13 g vitamin C and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example D3

Firstly, 1,000 g purified water was added into a heating container and heated to 40-50° C., 0.06 g monoammonium glycyrrhizinate was added and stirred evenly to be dissolved, then 0.02 g fumaric acid, 0.02 g tartaric acid, 0.02 g citric acid, 30 g xylitol and 48 g isomalt were added and heated to 95° C. after stirring and dissolving, and temperature was preserved for 7 minutes for sterilization, so as to prepare the functional compound sweetener having a theoretical sweetness to be 4 times than sucrose.

### Example D4

Firstly, 1,000 g purified water was added into a heating container and heated to 40-50° C., 0.15 g sucralose and 0.3 g trisodium glycyrrhizinate were added and stirred evenly to be dissolved, then 0.09 g acetic acid, 0.06 g adipic acid, 80 g erythritol and 30 g maltitol were added and heated to 95° C. after stirring and dissolving, and temperature was preserved for 7 minutes for sterilization, so as to prepare the functional compound sweetener having a theoretical sweetness to be 4 times than sucrose.

### Example D5

Firstly, 1,000 g purified water was added into a heating container and heated to 40-50° C., 0.3 g monoammonium glycyrrhizinate and 0.18 g rebaudioside A were added and stirred evenly to be dissolved, then 0.02 g fumaric acid, 0.02 g tartaric acid, 0.02 g acetic acid, 60 g erythritol and 60 g maltitol were added and heated to 95° C. after stirring and dissolving, and temperature was preserved for 7 minutes for sterilization, so as to prepare the functional compound sweetener having a theoretical sweetness to be 4 times than sucrose.

### Example D6

Firstly, 1,000 g purified water was added into a heating container and heated to 40-50° C. 0.75 g tripotassium glycyrrhinate and 0.02 g monellin were added and stirred evenly to be dissolved, then 0.02 g phosphoric acid, 0.05 g glutamic acid and (10 g erythritol were added and heated to 95° C. after stirring and dissolving, and temperature was preserved for 7 minutes for sterilization, so as to prepare the functional compound sweetener having a theoretical sweetness to be 4 times than sucrose.

### Example D7

Firstly, 3.000 g purified water was added into a heating container and heated to 40-50° C., 2.4 g ammonium glycyrrhetate was added and stirred evenly to be dissolved, then 0.45 g adipic acid, 100 g erythritol, 120 g isomaltulose and 100 g pectin were added and heated to 95° C. after stirring and dissolving, and temperature was preserved for 7 minutes for sterilization, so as to prepare the functional compound sweetener having a theoretical sweetness to be 4 times than sucrose.

### EXAMPLE SET E

### Example E1

Firstly, 1.000 g purified water was added into a heating container and heated to 40-50° C., 0.2 g curculin, 0.05 g betahistine and 0.05 g osladin were added and stirred evenly to be dissolved, then 0.06 g citric acid and 100 g erythritol were added and heated to 95° C. after stirring and dissolving, and temperature was preserved for 7 minutes for sterilization, so as to prepare the functional compound sweetener having a theoretical sweetness to be 4 times than sucrose.

### Example E2

Firstly, 1,000 g purified water was added into a heating container and heated to 40-50° C., 0.01 g thaumatin was added and stirred evenly to be dissolved, then 0.02 g fumaric acid, 0.02 g tartaric acid, 0.02 g citric acid, 80 g erythritol and 30 g maltitol were added and heated to 95° C. after stirring and dissolving, and temperature was preserved for 7 minutes for sterilization, so as to prepare the functional compound sweetener having a theoretical sweetness to be 4 times than sucrose.

### Example E3

Firstly, 1,000 g purified water was added into a heating container and heated to 40-50° C. 0.05 g monellin was added and stirred evenly to be dissolved, then 0.02 g phosphoric acid, 0.05 g glutamic acid, 30 g xylitol and 48 g isomalt were added and heated to 95° C. after stirring and dissolving, and temperature was preserved for 7 minutes for sterilization, so as to prepare the functional compound sweetener having a theoretical sweetness to be 4 times than sucrose.

### Example E4

Firstly, 1,000 g purified water was added into a heating container and heated to 40-50° C., 0.3 g thaumatin was added and stirred evenly to be dissolved, then 0.03 g citric acid, 100 g D-mannitol, 100 g erythritol and 100 g pectin were added and heated to 95° C. after stirring and dissolving, and temperature was preserved for 7 minutes for sterilization, so as to prepare the functional compound sweetener having a theoretical sweetness to be 4 times than sucrose.

Taste Comparison Experiments

Test Object

Thirty-two healthy men and women aged from 17 to 55 with seventeen men and fifteen women. All the subjects do not smoke, have normal taste sensation, and do not take any medicine that will change taste sensation.

Sample Preparation

Standard example: 75 mmol/L sucrose solution

Test example 1: a mixed solution having sucralose and erythritol in a weight ratio of 3:1000, and a sweetness consistent with that of 75 mmol L sucrose solution.

Test example 2: a mixed solution having steviol glycoside and erythritol in a weight ratio of 4:1000, and a sweetness consistent with that of 75 mmol/L sucrose solution.

Test example 3: a mixed solution having sucralose, erythritol and maltitol in a weight ratio of 3:800:300, and a sweetness consistent with that of 75 mmol/L sucrose solution.

Test example 4: a mixed solution having steviol glycoside, erythritol and maltitol in a weight ratio of 4:800:300, and a sweetness consistent with that of 75 mmol/L sucrose solution.

Test example 5: a mixed solution having sucralose, erythritol and maltitol in a weight ratio of 3:800:300, a sweetness consistent with that of 75 mmol/L sucrose solution, and a pH value of 3 by adding vitamin C.

Test example 6: a mixed solution having steviol glycoside, erythritol and maltitol in a weight ratio of 4:800:300, a sweetness consistent with that of 75 mmol L sucrose solution, and a pH value of 3 by adding citric acid.

The pH value in the examples is measured by a digital waterproof pH meter, such as, HM Digital pH Meter PH-200. The pH meter is calibrated by a standard pH 7.0 reference solution prepared by General Hydroponics. The device is calibrated before measurement.

Investigation and Classification

When the subjects judge taste difference to make classification, levels of taste difference between the sensed test solution and the standard solution are judged by levels of 0 to 5. Upon teaching, the subjects use “0” to present “no difference” or “tiny difference”, and use “5” to present “highest difference”.

Taste Difference Comparisons

Under room temperature, the subjects gargled with water at the same temperature, and then the subjects were required to drink 5 ml standard liquid all at once, and judge the taste within one minute. Later, after gargling with water at the same temperature, and resting for five minutes, the subjects drank 5 ml test solution all at once, and judged classification of taste difference between the test solution and the standard solution within one minute, including bitter taste, astringency, cool sensation, and sour aftertaste. In such way, taste difference between the respective test solutions and the standard solution was compared gradually.

Results and Analyses

The experiment results are shown in Table 1. The test data show that after the sugar substitute solution having the same sweetness is added with organic acid, it represents weak acid on the whole, and on the aspect of tastes of bitter taste, astringency, cool sensation, metallic taste, delayed sweet taste and sour aftertaste, with addition of sweetener buffer and organic acid, off tastes such as bitter taste, astringency, metallic taste, and the like caused by excessive sweetness or source factor of the high sweetness sweetener is diminished, such that the taste of the functional compound sweetener is closer to the taste of sucrose solution, and time delay of sweet tastes of the high sweetness sweetener is effectively improved.

TABLE 1
Comparison Results of Taste Difference Between
Test Solutions and Standard Solution

| | Test | Test | Test | Test | Test | Test |
|---|---|---|---|---|---|---|
| | Example 1 | Example 2 | Example 3 | Example 4 | Example 5 | Example 6 |
| Bitter Taste | 1.8 | 1.7 | 0.9 | 0.7 | 0 | 0.1 |
| Astringency | 2 | 2.1 | 1.3 | 1.3 | 0.1 | 0.2 |
| Cool | 2.1 | 2.2 | 1.1 | 1.1 | 0.3 | 0.4 |
| sensation | | | | | | |
| Metallic | 1.3 | 1.1 | 1 | 0.8 | 0.5 | 0.3 |
| Taste | | | | | | |
| Delayed | 3.8 | 3.9 | 2.7 | 2.8 | 1.1 | 1.3 |
| Sweet Taste | | | | | | |
| Sour | 4.5 | 4.3 | 3.8 | 3.2 | 0.5 | 0.6 |
| Aftertaste | | | | | | |

Sourness Comparison Experiments

Test Object

One hundred and fifty-eight healthy men and women aged from 17 to 55 with eighty-three men and seventy-five women. All the subjects do not smoke, have normal taste sensation, and do not take any medicine that will change taste sensation.

Sample Preparation

Standard solution and test solutions having consistent sweetness are prepared.

Standard solution: 75 mmol/L sucrose solution

Specific contents of respective compositions in the first group of sourness gradient test solutions are as shown in Table 2.

TABLE 2
Composition Contents of First Group of Test Solutions

| First | | Erythritol | Maltitol | Stevioside | Citric Acid |
|---|---|---|---|---|---|
| Group | pH | g/L | g/L | g/L | g/L |
| 1# | 2.5 | 4 | 4 | 0.03 | 0.0095 |
| 2# | 3.0 | 4 | 4 | 0.03 | 0.0085 |
| 3# | 3.5 | 4 | 4 | 0.03 | 0.0075 |
| 4# | 4.0 | 4 | 4 | 0.03 | 0.0065 |
| 5# | 4.5 | 4 | 4 | 0.03 | 0.0055 |
| 6# | 5.0 | 4 | 4 | 0.03 | 0.0045 |
| 7# | 5.5 | 4 | 4 | 0.03 | 0.0035 |
| 8# | 6.0 | 4 | 4 | 0.03 | 0.0025 |

Specific contents of respective compositions in the second group of sourness gradient test solutions are as shown in Table 3.

TABLE 3
Composition Contents of Second Group of Test Solutions

| Second | | Erythritol | Maltitol | Sucralose | Vitamin C |
|---|---|---|---|---|---|
| Group | PH | g/L | g/L | g/L | g/L |
| 1# | 2.5 | 4 | 4 | 0.04 | 0.009 |
| 2# | 3.0 | 4 | 4 | 0.04 | 0.008 |
| 3# | 3.5 | 4 | 4 | 0.04 | 0.007 |
| 4# | 4.0 | 4 | 4 | 0.04 | 0.006 |
| 5# | 4.5 | 4 | 4 | 0.04 | 0.005 |
| 6# | 5.0 | 4 | 4 | 0.04 | 0.004 |
| 7# | 5.5 | 4 | 4 | 0.04 | 0.003 |
| 8# | 6.0 | 4 | 4 | 0.04 | 0.002 |

The digital waterproof pH meter, such as, HM Digital pH Meter PH-200, is used to measure the pH values of samples. The pH meter is calibrated by a standard pH 7.0 reference solution prepared by General Hydroponics. The device is calibrated before measurement.

Investigation and Classification

When the subjects judge taste difference to make classification, levels of sourness difference between the sensed test solution and the standard solution are judged by levels of 0 to 5. Upon teaching, the subjects use “0” to present “no difference” or “tiny difference”, and use “5” to present “highest difference”.

Sourness Test

Under room temperature, the subjects gargled with water at the same temperature, then five drops of standard solution were quickly added to tongues of the subjects, and the subjects were required to judge the taste within one minute. After gargling with water at the same temperature, five drops of test solution were quickly added to tongues of the subjects to judge classification of taste difference between the test solution and the standard solution within one minute. Comparisons of taste difference between the first and second groups of sourness gradient test solutions and the standard solution are completed gradually in accordance with the above steps.

Results and Analyses

The experiment results are shown in Table 4. The test data show that taste difference brought by adding organic acid into the sugar substitute solution decreases as the pH value increases at the beginning, and then increases as the pH value increases. The pH values having the minimized difference for different sugar substitutes are different. As a whole, the sourness difference is ranging preferably from pH 3 to pH5.5 more preferably from pH 3.5 to pH 5, and still more preferably from pH 4 to pH4.5.

TABLE 4
Comparison Results of Sourness Difference Between Test Solutions and Standard Solution

| | pH = 2.5 | pH = 3.0 | pH = 3.5 | pH = 4.0 | pH = 4.5 | pH = 5.0 | pH = 5.5 | pH = 6.0 |
|---|---|---|---|---|---|---|---|---|
| First Group of | 4.9 | 3.2 | 2.2 | 1 | 0.7 | 1.2 | 2.1 | 4.0 |
| Test Solutions | | | | | | | | |
| Second Group of | 2.3 | 1.2 | 0.5 | 1.1 | 2.2 | 2.8 | 3.6 | 4.7 |
| Test Solutions | | | | | | | | |

Different combinations of sweetener+sweetener buffer with and without different organic acids in Table 5. All the combinations are the same concentration, 20 persons tasted the solution and then give a score, which from 0 to 10 points, the better the taste score is higher (Table 11). The score is higher for each combination with organic acid as shown in Table 5.

| | | | Concentration | | Score |
|---|---|---|---|---|---|
| No. | Components | Ratio | (g/mL) | pH | (n = 20). |
| ZLA1 | Sucralose + erythritol | 6:1000 | 0.1 | 6.9 | 5.6 |
| ZLA2 | Sucralose + erythritol + citric | 6:1000:1 | 0.1 | 3.4 | 6.2* |
| | acid | | | | |
| ZLB1 | Stevioside + erythritol | 4:1000 | 0.1 | 6.3 | 6.1 |
| ZLB2 | Stevioside + erythritol + citric | 4:1000:1 | 0.1 | 4.0 | 6.8* |
| | acid | | | | |
| ZLC1 | Aspartame + maltitol | 18:1000 | 0.1 | 6.3 | 5.9 |
| ZLC2 | Aspartame + maltitol + tartaric | 18:1000:1 | 0.1 | 4.5 | 6.1 |
| | acid | | | | |
| ZLD1 | Neotame + maltitol | 0.45:1000 | 0.1 | 6.6 | 5.0 |
| ZLD2 | Neotame + maltitol + tartaric | 0.45:1000:1 | 0.1 | 3.9 | 5.4* |
| | acid | | | | |
| ZLE1 | Mogrosides + erythritol | 12:1000 | 0.1 | 4.9 | 5.3 |
| ZLE2 | Mogrosides + erythritol + tartaric | 12:1000:1 | 0.1 | 4.3 | 5.5 |
| | acid | | | | |

*Statistically significant vs. sample without acid buffer, i.e., p < 0.05 in the two-tailed student t test.

The results of Table 5 show that the taste consistently improves when the acid buffer is present for all sweeteners. The differences are statistically different

The taste changes when the ratio of sweetener to sweetener buffer changes (Table 6). All the combinations are the same concentration, 20 persons tasted the solution and then give a score, which from to 10 points the better the taste score is higher (Table 11). With the increase of proportion of sweeteners taste score fell, this is because the sweet dose increased to certain degree, and the buffer can no longer offset undesirable tastes of the high sweetness sweetener. In the experiment of neotame+erthritol, it was found that the optimal taste ratio was 1:2500, and when the relative amount of sweetener buffer increased, the taste of the solution did not improve.

TABLE 6
Showing that the ratio of sweetener to sweetener buffer
is optimal within a specific critical range.

| | | | Concentration | | Score |
|---|---|---|---|---|---|
| No. | Components | Ratio | (g/mL) | pH | (n = 20). |
| ZLF1 | Aspartame + erythritol | 1:30 | 0.1 | 5.9 | 4.9 |
| ZLF2 | Aspartame + erythritol | 1:40 | 0.1 | 5.9 | 5.4 |
| ZLF3 | Aspartame + erythritol | 1:50 | 0.1 | 5.9 | 5.7 |
| ZLG1 | Sucralose + erythritol | 1:40 | 0.1 | 6.6 | 3.7 |
| ZLG2 | Sucralose + erythritol | 1:200 | 0.1 | 6.6 | 5.5 |
| ZLG3 | Sucralose + erythritol | 1:2500 | 0.1 | 6.6 | 5.8 |
| ZLH1 | Neotame + erythritol | 1:2000 | 0.1 | 6.7 | 5.1 |
| ZLH2 | Neotame + erythritol | 1:2500 | 0.1 | 6.7 | 5.7 |
| ZLH3 | Neotame + erythritol | 1:3000 | 0.1 | 6.7 | 5.5 |

In Table 7, the combinations of sweetener+sweetener buffer+organic acids are the same, but the ratio of sweetener is different. All the combinations are the same concentration, 20 persons tasted the solution and then give a score from 0 to 10 points the better the taste score is higher (Table 11). The best ratio for aspartame is 25:1000:1, the best ratio for sucralose is 5:1000:1, the best ratio for neotame is 0.4:1000:1. The sweetness of aspartame is low and the sweetness of neotame is high. The ratio of sweetener to sweetener buffer is optimally with in a range of 1:40˜1:2500.

TABLE 7
Showing that the ratio of sweetener to organic acid
is optimal within a critical range narrower.

| | | | Concentration | | Score |
|---|---|---|---|---|---|
| No. | Components | Ratio | (g/mL) | pH | (n = 20). |
| ZLJ1 | Aspartame + erythritol + citric | 0.4:1000:1 | 0.1 | 4.4 | 4.9 |
| | acid | | | | |
| ZLJ2 | Aspartame + erythritol +citric | 5:1000:1 | 0.1 | 3.9 | 5.1 |
| | acid | | | | |
| ZLJ3 | Aspartame + erythritol + citric | 25:1000:1 | 0.1 | 3.3 | 5.3 |
| | acid | | | | |
| ZLJ4 | Aspartame + erythritol + citric | 50:1000:1 | 0.1 | 4.5 | 5.2 |
| | acid | | | | |
| ZLK1 | Sucralose + erythritol + citric | 0.4:1000:1 | 0.1 | 3.9 | 5.3 |
| | acid | | | | |
| ZLK2 | Sucralose + erythritol + citric | 5:1000:1 | 0.1 | 3.7 | 5.6 |
| | acid | | | | |
| ZLK3 | Sucralose + erythritol + citric | 25:1000:1 | 0.1 | 4.0 | 5.0 |
| | acid | | | | |
| ZLK4 | Sucralose + erythritol + citric | 50:1000:1 | 0.1 | 3.9 | 4.2 |
| | acid | | | | |
| ZLL1 | Neotame + erythritol + citric | 0.4:1000:1 | 0.1 | 3.5 | 4.9 |
| | acid | | | | |
| ZLL2 | Neotame + erythritol + citric | 5:1000:1 | 0.1 | 3.9 | 2.4 |
| | acid | | | | |
| ZLL3 | Neotame + erythritol + citric | 25:1000:1 | 0.1 | 4.0 | 0.8 |
| | acid | | | | |
| ZLL4 | Neotame + erythritol + citric | 50:1000:1 | 0.1 | 4.4 | 0.4 |
| | acid | | | | |

In Table 8, the same combinations of sweetener buffer+organic acids are the same, but the sweetener is different. All the combinations are the same concentration, 20 persons tasted the solution and then give a score from 0 to 10 points, the better the taste score is higher (Table 11). The sweeteners are ranked in stevioside>mogrosides>sucralose, neotame>aspartame.

TABLE 8
Showing that certain sweeteners are optimal, e.g., all
rebaudiosides are similar, and differ from cyclamates.

| | | | Concentration | | Score |
|---|---|---|---|---|---|
| No. | Components | Ratio | (g/mL) | pH | (n = 20) |
| ZLM1 | Sucralose + maltitol + citric | 5:1000:1 | 0.1 | 3.4 | 5.3 |
| | acid | | | | |
| ZLM2 | Stevioside + maltitol + citric | 5:1000:1 | 0.1 | 3.4 | 6.2 |
| | acid | | | | |
| ZLM3 | Mogrosides + maltitol + citric | 15:1000:1 | 0.1 | 3.4 | 5.8 |
| | acid | | | | |
| ZLM4 | Aspartame + maltitol + citric | 25:1000:1 | 0.1 | 3.8 | 5.1 |
| | acid | | | | |
| ZLM5 | Neotame + maltitol + citric | 1:1000:1 | 0.1 | 3.4 | 5.3 |
| | acid | | | | |

The combinations of sweetener and sweetener buffer are the same, but the organic acid is different in Table 9. All the combinations are the same concentration, 20 persons tasted the solution and then give a score from 0 to 10 points, the better the taste score is higher (Table 11). The organic acids are ranked in citric acid>tartaric acid>fumaric acid>malic acid>VC>lactic acid.

TABLE 9
Showing that certain organic ions are optimal,
e.g., those with carboxylic acid groups.

| | | | Concentration | | Score |
|---|---|---|---|---|---|
| No. | Components | Ratio | (g/mL) | pH | (n = 20) |
| ZLN1 | Stevioside + maltitol + fumaric | 5:1000:1 | 0.1 | 3.1 | 5.3 |
| | acid | | | | |
| ZLN2 | Stevioside + maltitol + tartaric | 5:1000:1 | 0.1 | 3.5 | 5.4 |
| | acid | | | | |
| ZLN3 | Stevioside + maltitol + malic | 5:1000:1 | 0.1 | 3.4 | 5.2 |
| | acid | | | | |
| ZLN4 | Stevioside + maltitol + lactic | 5:1000:1 | 0.1 | 4.0 | 5.0 |
| | acid | | | | |
| ZLN5 | Stevioside + maltitol + VC | 5:1000:1 | 0.1 | 4.0 | 5.1 |
| ZLN6 | Stevioside + maltitol + citric | 5:1000:1 | 0.1 | 3.4 | 6.2 |
| | acid | | | | |

The combinations of sweetener+sweetener buffer+organic acids are the same, but the ratio of organic acid is different in Table 10. All the combinations are the same concentration, 20 persons tasted the solution and then give a score from 0 to 10 points, the better the taste score is higher (Table 11). The effective amount of organic acid is about 0.1 wt %. At higher that 1 wt %, the sweet taste of the sample decreases.

TABLE 10
Showing that the concentration of organic ions is effective
above a certain concentration or pH buffer power.

| | | | Concentration | | Score |
|---|---|---|---|---|---|
| No. | Component | Ratio | (g/mL) | pH | (n = 20). |
| ZLP1 | Aspartame + erythritol + citric | 25:1000:0.1 | 0.1 | 5.8 | 5.1 |
| | acid | | | | |
| ZLP2 | Aspartame + erythritol + citric | 25:1000:1 | 0.1 | 4.0 | 5.2 |
| | acid | | | | |
| ZLP3 | Aspartame + erythritol + citric | 25:1000:10 | 0.1 | 3.1 | 3.2 |
| | acid | | | | |
| ZLQ1 | Sucralose + erythritol + citric | 5:1000:0.1 | 0.1 | 5.9 | 5.3 |
| | acid | | | | |
| ZLQ2 | Sucralose + erythritol + citric | 5:1000:1 | 0.1 | 3.7 | 5.4 |
| | acid | | | | |
| ZLQ3 | Sucralose + erythritol + citric | 5:1000:10 | 0.1 | 2.8 | 3.5 |
| | acid | | | | |
| ZLR1 | Neotame + erythritol + citric | 1:1000:0.1 | 0.1 | 5.9 | 4.6 |
| | acid | | | | |
| ZLR2 | Neotame + erythritol + citric | 1:1000:1 | 0.1 | 3.7 | 5.3 |
| | acid | | | | |
| ZLR3 | Neotame + erythritol + citric | 1:1000:10 | 0.1 | 2.8 | 3.3 |
| | acid | | | | |

TABLE 11
showing individual scores for testing different test solutions of
Tables 5-10, above, and average (AVE) across the group of tasters.

| | 1 | 2 | 3 | 4 | 5 | 6 | 7 | 8 | 9 | 10 | 11 | 12 | 13 | 14 | 15 | 16 | 17 | 18 | 19 | 20 | AVE |
|---|---|---|---|---|---|---|---|---|---|---|---|---|---|---|---|---|---|---|---|---|---|
| ZLA1 | 5 | 6 | 7 | 4 | 4 | 3 | 4 | 8 | 7 | 7 | 6 | 8 | 7 | 4 | 5 | 4 | 7 | 6 | 5 | 5 | 5.6 |
| ZLA2 | 6 | 7 | 8 | 5 | 3 | 3 | 5 | 7 | 7 | 8 | 7 | 8 | 7 | 5 | 6 | 5 | 6 | 7 | 5 | 6 | 6.2* |
| ZLB1 | 6 | 5 | 7 | 6 | 8 | 5 | 5 | 7 | 7 | 6 | 6 | 8 | 6 | 6 | 5 | 5 | 6 | 6 | 6 | 5 | 6.1 |
| ZLB2 | 8 | 6 | 6 | 6 | 10 | 7 | 6 | 8 | 6 | 5 | 7 | 8 | 6 | 8 | 6 | 7 | 6 | 7 | 6 | 7 | 6.8* |
| ZLC1 | 7 | 7 | 5 | 6 | 5 | 4 | 4 | 7 | 5 | 4 | 8 | 7 | 7 | 9 | 5 | 4 | 5 | 5 | 5 | 8 | 5.9 |
| ZLC2 | 8 | 7 | 6 | 8 | 5 | 5 | 4 | 6 | 6 | 6 | 7 | 6 | 7 | 8 | 4 | 4 | 6 | 5 | 6 | 8 | 6.1 |
| ZLD1 | 7 | 6 | 4 | 6 | 6 | 5 | 4 | 4 | 4 | 5 | 6 | 5 | 3 | 6 | 4 | 3 | 4 | 6 | 5 | 6 | 5.0 |
| ZLD2 | 7 | 6 | 5 | 5 | 5 | 6 | 5 | 5 | 5 | 5 | 6 | 5 | 4 | 8 | 5 | 4 | 4 | 7 | 4 | 6 | 5.4 |
| ZLE1 | 7 | 5 | 4 | 7 | 5 | 5 | 4 | 4 | 7 | 5 | 6 | 5 | 5 | 7 | 5 | 4 | 5 | 4 | 5 | 6 | 5.3 |
| ZLE2 | 7 | 6 | 6 | 8 | 4 | 5 | 5 | 4 | 7 | 5 | 7 | 5 | 6 | 8 | 4 | 4 | 6 | 3 | 5 | 5 | 5.5 |
| ZLF1 | 5 | 6 | 8 | 3 | 4 | 6 | 5 | 5 | 8 | 4 | 6 | 8 | 7 | 4 | 2 | 2 | 4 | 5 | 3 | 2 | 4.9 |
| ZLF2 | 6 | 5 | 7 | 6 | 6 | 7 | 7 | 3 | 7 | 6 | 7 | 9 | 6 | 4 | 3 | 3 | 3 | 4 | 4 | 5 | 5.4 |
| ZLF3 | 7 | 5 | 9 | 5 | 6 | 8 | 7 | 7 | 5 | 7 | 5 | 9 | 5 | 3 | 3 | 4 | 6 | 3 | 3 | 7 | 5.7 |
| ZLG1 | 6 | 4 | 6 | 3 | 5 | 4 | 3 | 2 | 5 | 3 | 4 | 6 | 4 | 3 | 3 | 3 | 3 | 3 | 2 | 2 | 3.7 |
| ZLG2 | 5 | 7 | 8 | 4 | 4 | 5 | 6 | 5 | 5 | 6 | 7 | 8 | 8 | 3 | 4 | 5 | 6 | 5 | 4 | 4 | 5.5 |
| ZLG3 | 8 | 5 | 9 | 6 | 6 | 7 | 6 | 6 | 5 | 6 | 7 | 8 | 7 | 4 | 5 | 5 | 5 | 4 | 3 | 4 | 5.8 |
| ZLH1 | 5 | 7 | 8 | 5 | 7 | 5 | 7 | 5 | 4 | 6 | 7 | 7 | 6 | 3 | 3 | 3 | 4 | 4 | 2 | 4 | 5.1 |
| ZLH2 | 7 | 7 | 8 | 5 | 9 | 7 | 7 | 6 | 4 | 6 | 8 | 8 | 6 | 3 | 3 | 4 | 6 | 2 | 3 | 5 | 5.7 |
| ZLH3 | 7 | 6 | 9 | 5 | 8 | 7 | 7 | 3 | 4 | 4 | 7 | 8 | 7 | 3 | 4 | 3 | 6 | 4 | 2 | 6 | 5.5 |
| ZLJ1 | 4 | 5 | 6 | 6 | 5 | 5 | 5 | 2 | 2 | 5 | 5 | 5 | 5 | 5 | 4 | 6 | 7 | 6 | 4 | 5 | 4.9 |
| ZLJ2 | 2 | 5 | 6 | 6 | 6 | 7 | 4 | 5 | 3 | 4 | 7 | 6 | 6 | 4 | 5 | 6 | 4 | 5 | 5 | 6 | 5.1 |
| ZLJ3 | 2 | 5 | 6 | 5 | 6 | 8 | 4 | 5 | 2 | 3 | 8 | 5 | 8 | 8 | 6 | 5 | 4 | 4 | 6 | 6 | 5.3 |
| ZLJ4 | 2 | 8 | 6 | 5 | 6 | 6 | 3 | 5 | 3 | 6 | 7 | 5 | 6 | 5 | 5 | 8 | 4 | 1 | 7 | 5 | 5.2 |
| ZLK1 | 2 | 10 | 7 | 9 | 7 | 5 | 5 | 5 | 3 | 4 | 6 | 6 | 3 | 4 | 4 | 5 | 5 | 6 | 3 | 6 | 5.3 |
| ZLK2 | 4 | 5 | 6 | 6 | 7 | 8 | 4 | 5 | 2 | 7 | 8 | 5 | 4 | 3 | 6 | 9 | 5 | 6 | 4 | 8 | 5.6 |
| ZLK3 | 2 | 5 | 5 | 6 | 8 | 7 | 3 | 8 | 2 | 2 | 8 | 4 | 5 | 2 | 6 | 5 | 4 | 3 | 7 | 7 | 5.0 |
| ZLK4 | 3 | 3 | 4 | 6 | 4 | 7 | 4 | 5 | 2 | 3 | 7 | 4 | 3 | 2 | 5 | 7 | 4 | 1 | 6 | 4 | 4.2 |
| ZLL1 | 5 | 10 | 6 | 9 | 4 | 5 | 4 | 5 | 2 | 1 | 6 | 6 | 3 | 2 | 3 | 5 | 6 | 5 | 5 | 5 | 4.9 |
| ZLL2 | 0 | 0 | 3 | 4 | 2 | 6 | 1 | 7 | 1 | 1 | 4 | 5 | 0 | 0 | 0 | 0 | 2 | 1 | 7 | 3 | 2.4 |
| ZLL3 | 0 | 0 | 1 | 1 | 1 | 0 | 1 | 2 | 1 | 1 | 2 | 2 | 0 | 0 | −1 | 0 | 1 | 0 | 3 | 1 | 0.8 |
| ZLL4 | 0 | 0 | 0 | 0 | 0 | 0 | 1 | 2 | 1 | 0 | 2 | 2 | 0 | 0 | −1 | 0 | 1 | 0 | 0 | 0 | 0.4 |
| ZLM1 | 3 | 7 | 7 | 10 | 5 | 5 | 5 | 5 | 2 | 5 | 6 | 5 | 3 | 5 | 6 | 6 | 3 | 7 | 3 | 8 | 5.3 |
| ZLM2 | 6 | 6 | 8 | 8 | 5 | 8 | 5 | 3 | 2 | 8 | 5 | 5 | 5 | 7 | 6 | 10 | 7 | 7 | 4 | 8 | 6.2 |
| ZLM3 | 6 | 10 | 8 | 9 | 7 | 6 | 6 | 5 | 3 | 4 | 5 | 6 | 3 | 5 | 3 | 5 | 6 | 8 | 3 | 7 | 5.8 |
| ZLM4 | 3 | 10 | 6 | 9 | 8 | 6 | 5 | 5 | 2 | 4 | 4 | 5 | 2 | 3 | 3 | 5 | 6 | 7 | 2 | 6 | 5.1 |
| ZLM5 | 5 | 10 | 7 | 9 | 7 | 5 | 5 | 5 | 3 | 3 | 4 | 6 | 2 | 4 | 6 | 5 | 6 | 5 | 3 | 5 | 5.3 |
| ZLN1 | 6 | 7 | 6 | 7 | 9 | 5 | 6 | 5 | 2 | 6 | 3 | 6 | 2 | 3 | 6 | 8 | 6 | 4 | 2 | 7 | 5.3 |
| ZLN2 | 6 | 10 | 6 | 9 | 7 | 6 | 5 | 4 | 3 | 6 | 4 | 6 | 2 | 2 | 5 | 8 | 5 | 6 | 2 | 6 | 5.4 |
| ZLN3 | 5 | 7 | 5 | 9 | 7 | 7 | 5 | 3 | 3 | 7 | 3 | 7 | 2 | 3 | 5 | 6 | 5 | 5 | 2 | 7 | 5.2 |
| ZLN4 | 5 | 6 | 4 | 9 | 7 | 6 | 5 | 2 | 3 | 6 | 2 | 7 | 5 | 5 | 5 | 6 | 5 | 5 | 1 | 6 | 5.0 |
| ZLN5 | 6 | 10 | 4 | 9 | 7 | 5 | 5 | 4 | 4 | 5 | 2 | 5 | 2 | 4 | 5 | 6 | 4 | 7 | 1 | 7 | 5.1 |
| ZLN6 | 6 | 7 | 8 | 7 | 5 | 8 | 5 | 3 | 2 | 8 | 5 | 5 | 5 | 7 | 6 | 10 | 7 | 7 | 4 | 8 | 6.2 |
| ZLP1 | 7 | 5 | 4 | 9 | 7 | 3 | 5 | 6 | 3 | 4 | 5 | 4 | 3 | 3 | 5 | 8 | 5 | 8 | 3 | 5 | 5.1 |
| ZLP2 | 6 | 6 | 4 | 8 | 7 | 3 | 6 | 5 | 4 | 4 | 5 | 5 | 3 | 3 | 5 | 8 | 5 | 8 | 3 | 6 | 5.2 |
| ZLP3 | 6 | 3 | 2 | 4 | 10 | 1 | 2 | 2 | 2 | 1 | 2 | 6 | 1 | 2 | 3 | 3 | 6 | 3 | 2 | 3 | 3.2 |
| ZLQ1 | 3 | 10 | 5 | 7 | 5 | 5 | 5 | 5 | 2 | 5 | 5 | 8 | 4 | 4 | 5 | 7 | 5 | 4 | 3 | 6 | 5.3 |
| ZLQ2 | 4 | 10 | 4 | 9 | 7 | 6 | 6 | 5 | 4 | 1 | 5 | 5 | 4 | 3 | 5 | 7 | 4 | 7 | 4 | 8 | 5.4 |
| ZLQ3 | 6 | 3 | 2 | 4 | 9 | 3 | 2 | 5 | 3 | 2 | 2 | 7 | 0 | 1 | 3 | 4 | 4 | 3 | 2 | 4 | 3.5 |
| ZLR1 | 6 | 4 | 7 | 7 | 5 | 5 | 2 | 2 | 1 | 7 | 3 | 3 | 6 | 4 | 6 | 7 | 5 | 2 | 5 | 5 | 4.6 |
| ZLR2 | 5 | 6 | 6 | 9 | 5 | 6 | 4 | 4 | 2 | 6 | 3 | 6 | 6 | 4 | 6 | 7 | 6 | 4 | 5 | 6 | 5.3 |
| ZLR3 | 7 | 3 | 3 | 4 | 8 | 2 | 2 | 2 | 1 | 8 | 2 | 6 | 0 | 1 | 4 | 3 | 4 | 1 | 2 | 2 | 3.3 |

The intentions and the embodiments of the functional compound sweetener are explicitly disclosed through the examples, but those ordinary in the art shall understand that the above examples are only one of the preferable examples disclosed herein. For limitation of context, it is impossible to list all embodiments one by one herein, and any implementations that can embody the technical solution of the appended claims are within the extent of protection of the functional compound sweetener disclosed herein.

It shall be noted that the above disclosures are further specific explanations to the functional compound sweetener in combination with detailed embodiments, which are not to be construed as imposing limitations upon the claims. Under guidance of the above examples, those skilled in the art can make various modifications and variations on the basis of the above examples, and these modifications and variations fall into the extent of protection of the functional compound sweetener disclosed herein.

What is claimed is:

1. A functional compound sweetener comprising a sweetener composition comprising a high sweetness sweetener and a sweetener buffer in a weight ratio of 1:4 to 1:80000, and an acid buffer that maintains pH 2.5 to 5.5 when the composition is dissolved in water, wherein the composition imparts flavor temporal profile characteristics of sucrose.

2. The functional compound sweetener of claim 1, wherein the acid buffer maintains pH 3.0 to 5.0.

3. The functional compound sweetener of claim 2, wherein the acid buffer maintains pH 4.0 to 4.5.

4. The functional compound sweetener of claim 2, wherein the high sweetness sweetener is selected from the group consisting of a steviol glycoside, glycyrrhizin, mogroside, siamenoside, raspberry extract, thaumatin, curcurbin, monellin, mabinlin, brazzein, and hemandulcin.

5. The functional compound sweetener of claim 2, wherein the sweetener buffer is selected from the group consisting of xylitol, sorbitol, D-mannitol, maltitol, isomalt, erythritol, galactitol, lactitol, raffinose, lactose, maltose, alpha-D-glucose, alpha-D-mannose, alpha-D-xylose, alpha-D-galactose, beta-D-fructofuranose, beta-D-maltose, beta-D-lactose, gelatin, sodium caseinate, arabic gum, tamarind gum, sesbania gum, agar, sodium alginate, potassium alginate, carrageenan, pectin, xanthan gum, beta-cyclodextrin, sodium carboxymethylcellulose, sodium starch phosphate, sodium carboxymethyl starch, hydroxypropyl starch, and propylene glycol alginate.

6. The functional compound sweetener of claim 2, wherein the acid buffer is selected from the group consisting of tannic acid, lactic acid, tartaric acid, citric acid, fumaric acid, gluconic acid, hydroxycitric acid, malic acid, maleic acid, succinic acid, salicylic acid, creatine, glucosamine hydrochloride, glucono delta lactone, acetic acid, ascorbic acid, adipic acid, oxalic acid, n-butyric acid, methanoic acid, polyglutamic acid, phosphoric acid, phosphorous acid, polyphosphoric acid, carbonic acid, sodium dihydrogen phosphate, and inositol hexaphosphate.

7. The functional compound sweetener of claim 2, wherein the acid buffer is selected from the group consisting of citric acid, tartaric acid, fumaric acid, malic acid, vitamin C, lactic acid, glutamic acid, and phosphoric acid.

8. The functional compound sweetener of claim 2, wherein the acid buffer is about 0.1 wt % of the composition.

9. The functional compound sweetener of claim 2, wherein the high sweetness sweetener is selected from the group consisting of sucralose, steviol glycoside, aspartame, neotame, and mogroside.

10. The functional compound sweetener of claim 2, wherein the sweetener buffer is erythritol and/or maltitol.

11. The functional compound sweetener of claim 2, wherein the sweetener composition consists of sucralose; erythritol or maltitol; and citric acid.

12. The functional compound sweetener of claim 11, wherein the ratio of sucralose:erythritol or sucralose:maltitol is 5:1000.

13. The functional compound sweetener of claim 2, wherein the sweetener composition consists of stevioside; erythritol or maltitol; and an acid buffer selected from citric acid, tartaric acid, malic acid, lactic acid, vitamin C, and fumaric acid.

14. The functional compound sweetener of claim 13, wherein the ratio of stevioside:erythritol or stevioside:maltitol is 4:1000 to 5:1000.

15. The functional compound sweetener of claim 2, wherein the sweetener composition consists of aspartame; erythritol or maltitol; and citric acid or tartaric acid.

16. The functional compound sweetener of claim 15, wherein the ratio of aspartame:erythritol or aspartame:maltitol is 18:1000 to 25:1000.

17. The functional compound sweetener of claim 2, wherein the sweetener composition consists of mogrosides; erythritol or maltitol; and citric acid or tartaric acid.

18. The functional compound sweetener of claim 17, wherein the ratio of mogrosides:erythritol or mogrosides:maltitol is 12:1000.

19. The functional compound sweetener of claim 2, wherein the concentration of the sweetener composition is about 0.1 g/ml.

20. The functional compound sweetener of claim 19, wherein the relative concentration of the acid buffer in the sweetener composition is about 0.1 wt %.
